(19) United States
(12) Patent Application Publication
(10) Pub. No.: US 2024/0167569 A1
(43) Pub. Date: May 23, 2024

(54) MECHANICAL SEAL MATING RING WITH DIRECT THERMAL CONTROL

(71) Applicant: A.W. CHESTERTON COMPANY, Groveland, MA (US)

(72) Inventors: Joseph K. KALESHIAN, Burlington, MA (US); Henri Vincent AZIBERT, Windham, NH (US); Robert James POWERS, Salem, MA (US)

(21) Appl. No.: 18/514,566

(22) Filed: Nov. 20, 2023

Related U.S. Application Data
(60) Provisional application No. 63/427,582, filed on Nov. 23, 2022.

(51) Int. Cl. F16J 15/34

(52) U.S. Cl. CPC F16J 15/3448

(57) ABSTRACT

A mechanical seal assembly having a gland element configured to mount to stationary equipment, a rotary seal ring for coupling to and rotating with a shaft, a stationary seal ring configured to remain stationary relative to the shaft where the stationary seal ring has a main body having an outer surface having a heat transfer channel formed therein that is sized and configured for circulating a heat transfer fluid, and a holder element for coupling the rotary seal ring to the shaft and for rotating with the shaft. The heat transfer channel can be a low pressure heat transfer channel.

### RELATED APPLICATIONS

The present application claims priority to provisional patent application Ser. No. 63/427,582, filed on Nov. 23, 2022, and entitled Mechanical Seal Mating Ring With Direct Thermal Control, the contents of which are herein incorporated by reference.

### BACKGROUND OF THE INVENTION

The present invention is directed to mechanical seals, and more specifically is directed to mechanical seals that employ an integrated cooling system.

Conventional mechanical seals are employed in a wide variety of mechanical apparatuses to provide a pressure-tight and fluid-tight seal. The mechanical seal is usually positioned about a rotating shaft that is mounted in and protruding from stationary equipment. The mechanical seal is usually bolted to the stationary equipment at the shaft exit, thus preventing the loss of pressurized process fluid from the stationary equipment. Conventional split mechanical seals include face-type mechanical seals, which include a pair of seal rings that are concentrically disposed about the shaft and are axially spaced from each other. The seal rings each have sealing faces that are biased into sealing contact with each other. Usually, one seal ring remains stationary while the other seal ring is coupled to the shaft and rotates therewith. The mechanical seal prevents leakage of the pressurized process fluid to the external or ambient environment by biasing the seal ring sealing faces into sealing contact with each other. The rotary seal ring is usually mounted in a holder assembly or on a sleeve which is disposed in a chamber formed by a gland assembly and the stationary equipment. If employed, the holder assembly can have a pair of holder halves or segments secured together by a screw. Likewise, the gland assembly can have a pair of gland halves or segments that are also secured together by a screw. The seal rings are also often divided into segments, each segment having a pair of sealing faces, thereby resulting in each ring being a split ring that can be mounted about the shaft without the necessity of freeing one end of the shaft.

Conventional mechanical seals have rotary and stationary components assembled around the shaft and then bolted on to the stationary equipment to be sealed. A rotary seal face is inserted into a rotary metal clamp after the segments are assembled around the shaft. Then, the stationary face segments and gland segments are assembled, and the split gland assembly is then bolted to the pump housing. Alternatively, the stationary and rotary sealing components can be preassembled into subassemblies that can then be mounted about the shaft.

During operation, the seal rings can be subjected to potentially damaging temperatures, especially if the seal rings are run in a dry environment, that is, in the absence of a liquid process fluid. Thus, cooling the seal rings in the mechanical seal is important to preventing overheating of the seal rings and to ensure the efficient operation of the mechanical seal. According to one conventional technique, a cooling or barrier fluid, such as water or a water-based coolant, can be introduced into the mechanical seal through a dedicated cooling jacket or gland chamber built into the mechanical seal. In this method, the cooling fluid flows externally around one or more of the seal rings, absorbing heat generated during operation, and then exits the system, often passing through a heat exchanger to remove excess heat. The cooling fluid can be recirculated using a pump, creating a continuous cooling loop to maintain the seal rings at a stable and lower temperature. However, this conventional cooling technique suffers from several drawbacks. For example, installing and maintaining a cooling fluid system for the mechanical seal can be complex and costly, and can require additional components like cooling jackets, pumps, and heat exchangers. Further, mechanical seals need to prevent fluid leakage, and adding additional fluid connections for cooling fluid introduces additional potential leakage points where leaks can occur. Also, if the cooling fluid is not properly filtered and maintained, it can become contaminated and negatively affect seal performance.

According to an alternate cooling technique, an external flush or quench is another effective technique for cooling the seal rings. This conventional cooling method involves directing a flow of a cooling fluid, typically from an external source, onto the seal rings or between them. The cooling fluid can be introduced through dedicated nozzles or channels formed in the gland and is typically directed to the contact area of the seal rings, where friction and heat are generated. The cooling fluid helps dissipate the heat generated during operation, maintaining a lower temperature at the seal faces and preventing excessive wear and damage to the seal rings. However, this conventional cooling technique also suffers from several drawbacks. For example, the external flush system requires a continuous supply of cooling fluid, which can result in fluid waste, especially if the cooling fluid is valuable or in limited supply. Further, the disposal of excess cooling fluid can have environmental consequences, especially if the fluid is chemically or environmentally harmful. Compatibility issues may arise if the cooling fluid used is not compatible with the process fluid, leading to potential chemical reactions or contamination.

### SUMMARY OF THE INVENTION

The present invention uses a nonconventional approach to cool or heat mechanical seals without the use of elaborate external piping systems. The mechanical seal assembly of the present invention includes an integral heat transfer channel formed directly in an outer surface of the stationary seal ring that allows for the localized circulation of a fluid, such as a heat transfer fluid, to cool or directly heat the stationary seal ring separate and independent from the process fluid. The heat transfer fluid can be contained or encapsulated within the heat transfer channel by a cover ring that serves to seal the heat transfer fluid within the channel while concomitantly isolating the heat transfer fluid from the process fluid. This fluid isolation technique helps prevent the accidental dilution of the process fluid by mixing together the process fluid and the heat transfer fluid.

In comparison to conventional piping plans, the present invention reduces the life cycle costs of the operating parameters of the mechanical seal assembly by eliminating the need and costs associated with complex external temperature controls and flush pressurization systems. For dry running conditions, the present invention enhances the operating pressure-velocity (PV) limit due to localized thermal conditioning. The operating PV limit is a parameter that defines the maximum pressure and velocity conditions under which the mechanical seal assembly can effectively function without experiencing premature failure. The PV limit is typically expressed in units of pressure multiplied by velocity. The PV limit can be influenced by factors such as the seal material, design, and the specific application conditions. Different seal materials and designs have varying PV limits. The PV limit helps prevent excessive wear, friction, and heat generation within the mechanical seal assembly, which can lead to degradation and failure.

For the stationary seal ring, the present invention can conform to standard single cartridge mechanical seal dimensions and performance. Further, the mechanical seal assembly of the present invention can employ optional standalone modular cooling or steam generating units that can be used for circulating heat transfer fluids depending on application requirements.

The present invention is directed to a mechanical seal assembly comprising a gland element configured to mount to stationary equipment, a rotary seal ring for coupling to and rotating with a shaft, a stationary seal ring configured to remain stationary relative to the shaft where the stationary seal ring has a main body having an outer surface having a heat transfer channel formed therein that is sized and configured for circulating a heat transfer fluid, and a holder element for coupling the rotary seal ring to the shaft and for rotating with the shaft. The heat transfer channel can be a low pressure heat transfer channel.

The mechanical seal assembly further includes a cover element that is disposed between the gland element and the stationary seal ring. The cover element can be sized and configured for seating over the heat transfer channel formed in the outer surface of the stationary seal ring. The cover element has a main body having a plurality of fluid openings formed therein for allowing passage of the heat transfer fluid into the heat transfer channel. The main body of the cover element includes an outer surface and an opposed inner surface, a first radially inwardly extending side portion formed at one end of the main body, and a second radially inwardly extending portion formed at an opposed end of the main body. The outer surface of the stationary seal ring has a stepped surface coupled to the outer surface by a wall surface. The first radially inwardly extending side portion is sized and configured to contact the wall surface of the stationary seal ring and the second radially inwardly extending side portion contacts a top surface of the stationary seal ring to form a fluid tight seal. Further, first radially inwardly extending side portion is sized and configured to extend partly along the wall surface and is spaced from the stepped surface of the stationary seal ring to form a gap.

The gland element has an inner surface, an opposed outer surface, and a top surface. The top surface has a gland channel formed along an inner radial portion thereof. The cover element further includes a radially outwardly extending front extension portion configured for contacting and seating within the gland channel to form a seal against the gland element. The front extension portion forms an anti-rotation mechanism to prevent rotation of the cover element relative to the stationary seal ring. The gland element also has a main body having an inner surface and an opposed outer surface and has at least one fluid inlet port formed in the main body and at least fluid outlet port formed in the main. The fluid inlet port and the fluid outlet port are circumferentially spaced apart from each other and extend completely between the outer surface and the inner surface of the gland element. The cover element is positioned between the inner surface of the gland element and the outer surface of the stationary seal ring such that the fluid inlet port is aligned with at least one of the plurality of fluid openings and the fluid outlet port is aligned with another one of the plurality of fluid openings.

The holder element includes a sleeve element having an axially extending inner surface that is disposed adjacent to an outer surface of the shaft when mounted thereabout and an opposed outer surface, and a flange end formed at one end for coupling to the rotary seal ring. The mechanical seal assembly also include an optional connecting pin for coupling to the flange end of the sleeve element for coupling the rotary seal ring to the flange end, and a biasing assembly disposed within the flange end of the sleeve element for contacting the rotary seal ring and for biasing together a sealing surface of the rotary seal ring and a sealing surface of the stationary seal ring. The biasing assembly includes a support element for contacting an end region of the rotary seal ring opposite the sealing surface, and a biasing element for contacting the support element for applying an axial biasing force thereto.

The mechanical seal assembly of the present invention can also include an optional positioning and retention element that is disposed so as to contact the front extension portion and the gland element for positioning and retaining the stationary seal ring within the gland element, and a securing assembly for securing the sleeve element to the shaft and for securing in place the positioning and retention element.

The heat transfer channel of the stationary seal ring has a floor portion having one or more optional protrusions radially outwardly extending therefrom to form an extended heat transfer element that increases the size of the heat transfer surface of the heat transfer channel. The protrusion can optionally have a height that is less than a height of a radially extending wall element of the channel to promote circulation of the heat transfer fluid within the channel. Still further, the protrusion can optionally have a spiral or helical shape to generate a turbulent flow of the heat transfer fluid within the heat transfer channel.

### BRIEF DESCRIPTION OF THE DRAWINGS

These and other features and advantages of the present invention will be more fully understood by reference to the following detailed description in conjunction with the attached drawings in which like reference numerals refer to like elements through the different views. The drawings illustrate principals of the invention and, although not to scale, show relative dimensions.

FIG. 1 is a partial cross-sectional view of a mechanical seal assembly according to the teachings of the present invention.

FIG. 2 is a partial cross-sectional view of a mechanical seal assembly according to the teachings of the present invention showing the stationary seal ring and cover element assembly.

FIG. 3 is a cross-sectional view of a mechanical seal assembly according to the teachings of the present invention showing the inlet and outlet fluid ports formed in the gland element.

FIG. 4A is a perspective view of an assembly formed by the cover element and the stationary ring according to the teachings of the present invention.

FIG. 4B is a partial cross-sectional view of the assembly of FIG. 4A according to the teachings of the present invention.

FIG. 5A is a perspective view of the cover element of the mechanical seal assembly according to the teachings of the present invention.

FIG. 5B is a partial cross-sectional view of the cover element of the mechanical seal assembly according to the teachings of the present invention.

FIG. 5C is a partial cross-sectional view of the assembly of FIG. 4A according to the teachings of the present invention.

FIG. 6 is an alternate embodiment of the cover element of the mechanical seal assembly 10 of the present invention having n integrated channel/FIG. 7 is an alternate embodiment of the stationary seal ring of the mechanical seal assembly 10 of the present invention having a heat transfer channel with a surface feature.

FIG. 8 is another alternate embodiment of the stationary seal ring of the mechanical seal assembly 10 of the present invention having a heat transfer channel with a spiral type surface feature.

FIG. 9 is still another alternate embodiment of the stationary seal ring of the mechanical seal assembly 10 of the present invention having a heat transfer channel formed by an additive manufacturing technique to have a complex four-sided configuration.

### DETAILED DESCRIPTION

The present invention is directed to a mechanical seal assembly having an integral heat transfer channel formed directly in an outer surface of a stationary seal ring that allows for the localized circulation of a fluid, such as a heat transfer fluid, to directly cool or heat the stationary seal ring separate and independent from the process fluid. The heat transfer fluid can be contained or encapsulated within the heat transfer channel by a cover element or ring that serves to seal the heat transfer fluid within the heat transfer channel while concomitantly isolating the heat transfer fluid from the process fluid.

The terms “mechanical seal assembly,” “mechanical seal,” “sealing system” and “sealing assembly” as used herein are intended to include various types of mechanical fluid sealing systems, including single or solid seals, split seals, concentric seals, spiral seals, cartridge seals, and other known mechanical seal and sealing types and configurations.

The term “shaft” is intended to refer to any suitable device in a mechanical system to which a mechanical seal can be mounted and includes shafts, rods and other known devices. The shafts can move in any selected direction, such as for example in a rotary direction or in a reciprocating direction.

The terms “axial” and “axially” as used herein refer to a direction generally parallel to the axis of a shaft. The terms “radial” and “radially” as used herein refer to a direction generally perpendicular to the axis of a shaft. The terms “fluid” and “fluids” refer to liquids, gases, and combinations thereof.

The terms “axially inner” or “axially inboard” as used herein refer to the portion of the stationary equipment and a mechanical seal proximate the stationary equipment employing the mechanical seal. Conversely, the terms “axially outer” or “axially outboard” as used herein refer to the portion of stationary equipment and a seal assembly distal from the mechanical system.

The term “radially inner” as used herein refers to the portion of the mechanical seal proximate a shaft. Conversely, the term “radially outer” as used herein refers to the portion of the mechanical seal distal from a shaft.

The terms “stationary equipment,” “stuffing box” and/or “static surface” as used herein are intended to include any suitable stationary structure housing a shaft or rod to which a mechanical seal or packing loading assembly having a gland is secured. The stationary structure can include any type of commercial or industrial equipment such as pumps, valves, and the like. Those of ordinary skill in the relevant art will readily recognize that the gland assembly can form part of the mechanical seal, packing loading assembly or part of the stationary equipment.

The terms “process medium” and/or “process fluid” as used herein generally refers to the medium or fluid being transferred through the stationary equipment. In pump applications, for example, the process medium is the fluid being pumped through the pump housing.

The term “gland” as used herein is intended to include any suitable structure that enables, facilitates, or assists securing the mechanical seal to the stationary equipment, while concomitantly surrounding or housing, at least partially, one or more seal components. If desired, the gland can also provide fluid access to the mechanical seal. Those of ordinary skill will also recognize that the gland assembly can form part of the mechanical seal assembly or form part of the stationary equipment.

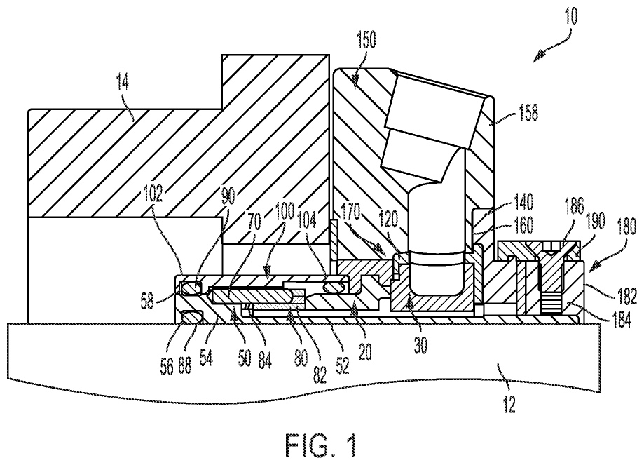

As shown in FIGS. 1-3, a mechanical seal assembly 10 according to the teachings of the present invention is preferably concentrically disposed about a shaft 12 and can be secured to an external wall of stationary equipment 14 by fasteners, such as gland bolts. The mechanical seal assembly 10 provides a fluid-tight seal, thereby preventing a process medium or fluid, such as hydraulic fluid, from escaping the stationary equipment 14. The fluid-tight seal is achieved by a pair of sealing members, illustrated as a rotary seal ring 20 and a stationary seal ring 30, that form a fluid seal therebetween. Each of the seal rings can have a smooth arcuate sealing surface 26, 36. The smooth arcuate sealing surface of each seal ring is biased into sealing contact with the corresponding sealing surface of the other seal ring. Preferably, the seal rings are split into a pair of segments, respectively, to facilitate installation, as described below. The sealing surfaces 26, 36 of the seal rings 20, 30 provide a fluid-tight seal operable under a wide range of operating conditions, including a vacuum condition and dry running conditions. The rotary seal ring 20 can be mounted within and to a holder element, such as a sleeve element 50. The sleeve element 50 can be coupled to the shaft 12 and is rotatable therewith. The sleeve element 50 can be disposed between the seal rings 20, 30 and the stationary equipment 14. The sleeve element 50 can function as a protective barrier and a sealing interface between the shaft 12 and the seal rings, thus ensuring effective sealing while preventing the leakage of fluids from the stationary equipment 14. The sleeve element 50 helps accurately align the seal faces of the seal rings in the axial direction. Proper axial alignment of the seal faces helps ensure that the seal faces make consistent contact, minimizing wear and preventing fluid leakage therebetween. The sleeve element 50 also serves as a support structure for the seal rings 20, 30 and helps encapsulate the shaft 12, helping to maintain the correct spacing and alignment between the rotating and stationary components of the mechanical seal assembly 10. The sleeve element 146 also ensures that the seal rings 20, 30 remain securely in place and do not inadvertently shift or move during operation, which can lead to leaks or inefficient sealing.

The illustrated sleeve element 50 can have a main body having an inner surface 52 that is disposed immediately adjacent to and contacts an outer surface of the shaft 12. The main body can also have an axially inboard flange end 54 that helps seat or mount the rotary seal 20. The rotary seal ring 20 can be mechanically coupled to the flange end 54 by a connecting pin 70 and an inboard biasing assembly 80. The biasing assembly 80 can include a support element 82 for contacting an end region of the rotary seal ring and a biasing element 84, such as a spring, that can help provide for axial movement of the seal rings during operation. The connecting pin 70 helps connect the biasing assembly 80 to the sleeve element 50, and the rotary seal ring 20 is mechanically coupled to the sleeve element 50 such that the rotary seal ring rotates therewith. The support element 82 has an end region that contacts the end region of the rotary seal ring 20 opposite the sealing surface 26, and an opposed end region. The biasing element 84 contacts the opposed end region at one end and the flange end 54 at the opposite end to provide an axial biasing force to the support element 82, which in turn provides an axial biasing force to the rotary seal ring. The axial biasing force applied to the rotary seal ring 20 biased the sealing surfaces 26, 36 into sealing contact with each other. The inner surface 52 of the sleeve element 50 at the flange end 54 can have an inner groove 56 formed therein for seating a sealing element 88, such as an O-ring. The sealing element 88 forms a fluid tight seal between the sleeve element 50 and the shaft 12 to prevent process fluid from leaking between the inner surface 52 of the sleeve element 50 and the outer surface of the shaft 12. The flange end 54 can have an outer surface that has an outer groove 58 formed therein for seating a sealing element 90, such as an O-ring.

The illustrated mechanical seal assembly 10 can also include a holder element 100 that overlies the flange end 54 of the sleeve element for seating the sleeve element 50 and the rotary seal ring 20 therein. The holder element 100 has a main body having a first end region 102 that overlies the flange end 54 of the sleeve element 50 and an opposed second and region 104 that overlies at least a portion of a main body of the rotary seal ring 20. The holder main body has an inner surface 106 and an opposed outer surface 108. The inner surface 106 at the second end 104 has a holder groove 110 formed therein for seating a sealing element 92, such as an O-ring. The sealing element 92 is configured and positioned to seat against an outer surface of the rotary seal ring to form a fluid-tight seal. The inner surface at the first end region 102 contacts the sealing element 90 to form a fluid tight seal between the holder element 100 and the sleeve element 50.

The illustrated rotary seal ring 20 has a main body having an outer surface 22, a bottom surface 24, and an opposed top sealing surface 26. The outer surface 22 contacts the sealing element 92 to form the fluid tight seal between the holder element 100 and the rotary seal ring 20. The bottom surface 24 is configured and positioned to contact a terminal end of the support element 82. The sealing surface 26 is configured and positioned to contact the stationary seal ring 30.

The illustrated stationary seal ring 30 has a main body having an outer surface 32A and an opposed inner surface 32B, a top surface 34, and a bottom sealing surface 36. The sealing surface 36 contacts the sealing surface 26 of the rotary seal ring 20 during use to form a fluid seal between the seal rings. The top surface 34 is configured to contact either a portion of a cover element 120 or a positioning and retention element 140. The outer surface 32 of the stationary seal ring 20 has a channel 40 formed therein to form a heat transfer channel. The outer surface 32 also includes a stepped surface 38 formed by a radially extending connecting wall surface 39. The channel 40 can have any selected depth or width. According to one embodiment, the channel 40 can be configured to form a low pressure heat transfer channel. As used herein, the term “low pressure heat transfer channel” is intended to mean a passage, conduit or channel formed in a selected surface of one of the seal components, such as in the outer surface 32 of the stationary seal ring 30, that has a selected size, including a selected depth and width, that promotes or is responsible for the controlled and intentional transfer of heat from or to the selected surface while forming, creating, or maintaining a fluid pressure or pressure drop within the channel of about 1.0 PSI or less. The channel 40 serves the purpose, according to one practice of the present invention, of dissipating excess heat generated at the interface of the sealing surfaces 26, 36, thus promoting temperature regulation and efficient heat dissipation from the channel 40 without causing a significant or unwanted impact on the overall pressure conditions within the mechanical seal assembly 10. By allowing for the controlled and ow pressure flow of a heat transfer fluid, typically a cooling medium, the channel 40 helps mitigate temperature rise at the sealing components, ensuring optimal operating conditions and enhancing the longevity and performance of the seal rings. The channel 40 can also be sized to have an internal diameter column width that is capable of supporting the rotary ring balance line. The channel is also sized and configured to maximize or optimize the flow of the heat transfer fluid therein with minimal flow interruptions. The channel can also be sized and configured to increase the overall heat transfer surface area to optimize and maximize the heat transfer that occurs in the channel.

The illustrated mechanical seal assembly 10 also includes a gland element 150 that is positioned so as to be secured to the stationary equipment 14 by way of suitable fasteners, such as gland bolts (not shown). The gland element 150 forms a space that serves to house and support the stationary seal ring 30 and to provide a secure and controlled environment for proper sealing function. The gland element 150 also facilitates or assists with the alignment of the sealing surfaces 26, 36 by positioning and aligning the stationary seal ring 30. The gland element 150 further contributes to the containment of pressure within the mechanical seal assembly 10 and helps prevent the process fluid from leaking into the surrounding environment while concomitantly maintaining the pressure necessary for the mechanical seal assembly to function effectively. The gland assembly 150 and the holder element 100, and optionally the sleeve element 50, can be solid or can be split into a pair of arcuate segments to facilitate easy assembly and installation of the mechanical seal assembly.

The illustrated gland assembly 150 has a main body having an inner surface 152 and an opposed peripheral or outer surface 154. The outer surface 154 has a plurality of fluid openings or ports 156 formed therein that extend between the inner and outer surfaces 152, 154. The fluid ports 156 can include at least one fluid inlet port 156A and at least one fluid outlet port 156B. The fluid ports 156A, 156B can be circumferentially spaced apart from each about the circumference of the gland element 150. According to one embodiment, if a single inlet port and a single outlet port are employed, the fluid ports can be spaced apart by about 180 degrees. The fluid inlet port 156A can be coupled to a fluid source for providing a heat transfer fluid, such as a cooling fluid, to the stationary seal ring 30. The fluid outlet port 156B can allow for the removal or extraction of the heat transfer fluid from the mechanical seal assembly. The extracted fluid can be heated or cooled and then optionally reintroduced to the seal assembly through the fluid inlet port 156A to form a closed loop heat transfer system. Alternatively, a single fluid port 156 can be employed that functions as both the fluid inlet port and the fluid outlet port. The fluid ports 156 thus allow for fluid communication between the inner space or region of the gland element 150, and hence the seal rings, with the externally supplied heat transfer fluid. The heat transfer fluid can be any suitable fluid or medium capable of transferring heat from one location or component to another. The fluid can be employed to facilitate the exchange of thermal energy, either by absorbing heat from a heat source or releasing heat to a heat sink. The gland element 150 can also include a top surface 158 that has a plurality of fastener receiving apertures 160 formed therein for receiving the fasteners. The top surface 158 can have a gland channel 160 formed along an inner radial portion for seating selected components, such as a portion of the cover element and the positioning and retention element 140.

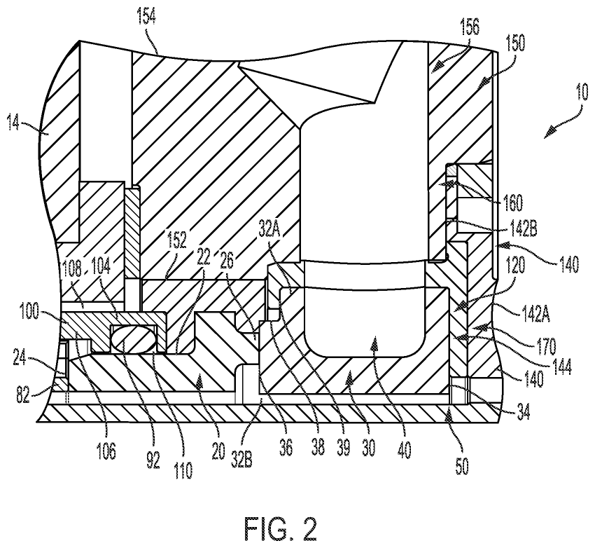

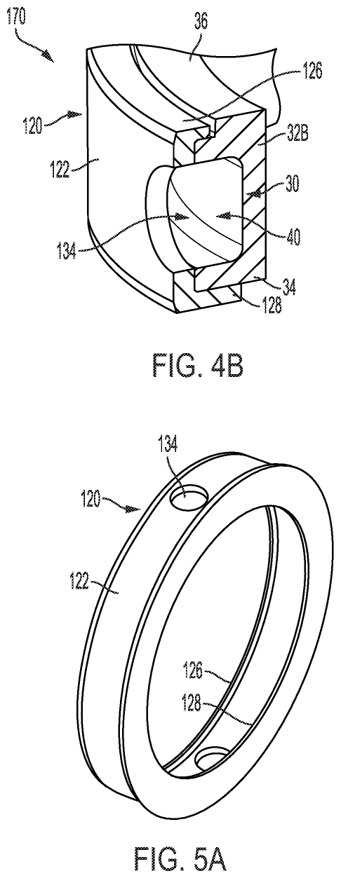

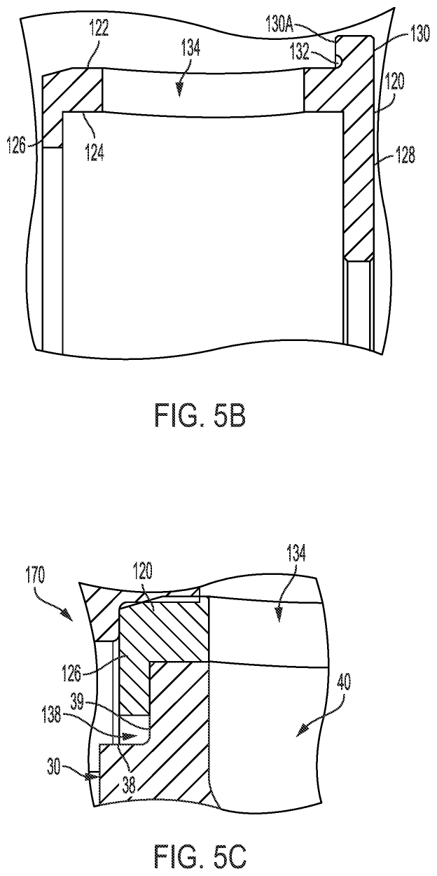

With reference to FIGS. 2-5C, the mechanical seal assembly 10 can further include a housing or cover element 120 that is sized and configured to seat over and cover the heat transfer channel 40 to form a fluid tight seal. The mating together of the cover element 120 and the stationary seal ring 30, where the cover element overlies the channel 40, helps form a fluid chamber for holding and allowing passage of the heat transfer fluid therein. The illustrated cover element 120 has a main body having an outer surface 122 and an opposed inner surface 124. The inner surface 124 has a first radially inwardly extending side portion 126 formed at one axial end of the main body and a second radially inwardly extending side portion 128 formed at an opposed axial end of the main body. The main body of the cover element 120 also includes a radially outwardly extending front extension portion 130. The front extension portion 130 has an inner surface 130A that has a groove 132 formed therein. The outer surface 122 can also include or have formed therein one or more fluid openings 134. The number of fluid openings 134 formed in the cover element 120 can correspond to the number of fluid ports 156 formed in the gland element 150. The fluid openings 134 can have any selected shape, such as for example a circular or an elliptical shape, and the fluid openings 134 can be of any selected size. According to one embodiment, the fluid openings can be elliptical in shape to form elongated slotted holes or openings to allow for easy alignment of the cover element 120 with the fluid ports 156 formed in the gland element 150.

As shown in FIGS. 2, 4A, 4B, and 5C, when mounted within the mechanical seal assembly 10, the cover element 120 is positioned between the inner surface 152 of the gland element 150 and the outer surface of the stationary seal 30. The fluid ports 156 are aligned with the fluid openings 134 formed in the cover element 120. The cover element 120 is configured to seat over the outer surface 32A of the stationary seal ring 30, and specifically is configured to seat over the heat transfer channel 40 formed in the outer surface of the stationary seal ring to form a stationary seal assembly 170. In this position, the cover element 120 is configured to seat over the outer surface 32A of the stationary seal ring 30 to form the heat transfer fluid chamber, and specifically is configured to seat over the heat transfer channel 40 formed in the outer surface of the stationary seal ring. The side portion 126 of the cover element 120 overlies and directly contacts the radially extending wall surface 39 of the stationary seal ring 30 to form a fluid tight seal. The side portion 126 extends partly along the wall surface 39 and preferably does not contact the stepped surface 38 to form a gap 138. The side portion 126 thus functions as an undercut feature and allows the process fluid to form or provide a contact force against the radially extending surface of the cover element 120. The undercut feature formed by the side portion also allows for the nesting and unitizing of the cover element and the stationary seal ring to form the stationary seal ring assembly 170. The gap 138 (e.g., radial clearance) also allows the process fluid to contact the stationary seal ring 30 to promote additional heat transfer by the process fluid. The side portion 128 of the cover element 120 overlies and directly contacts the top surface 34 of the stationary seal ring 30 to form a fluid tight seal. The cover element thus can seat over the channel 40 of the stationary seal ring 30 via a mechanical or friction fit. The front extension portion 130 of the cover element 120 overlies and directly contacts the gland channel 160 formed in the top surface 158 of the gland element 150. The front extension portion 130 provides for and forms a seal against the gland element 150 and the stationary seal ring 30 via a mechanical fit. The front extension portion 130 can also serve as an anti-rotation mechanism to prevent unwanted and inadvertent rotation of the cover element 120 relative to the stationary seal ring 30. The stationary seal ring assembly 170 formed by the mounting together of the cover element 120 and the stationary seal ring 30 forms a radially and axially sealed heat transfer channel 40 (e.g., fluid chamber) allowing localized thermal conditioning of the stationary seal ring 30 independent from the process fluid, thereby avoiding unwanted process fluid dilution. Further, the pressure within the stationary seal ring channel 40 is independent of the pressure of the process fluid. Further, the cover element 120 functions to enclose and seal the heat transfer channel 40 of the stationary seal ring 30.

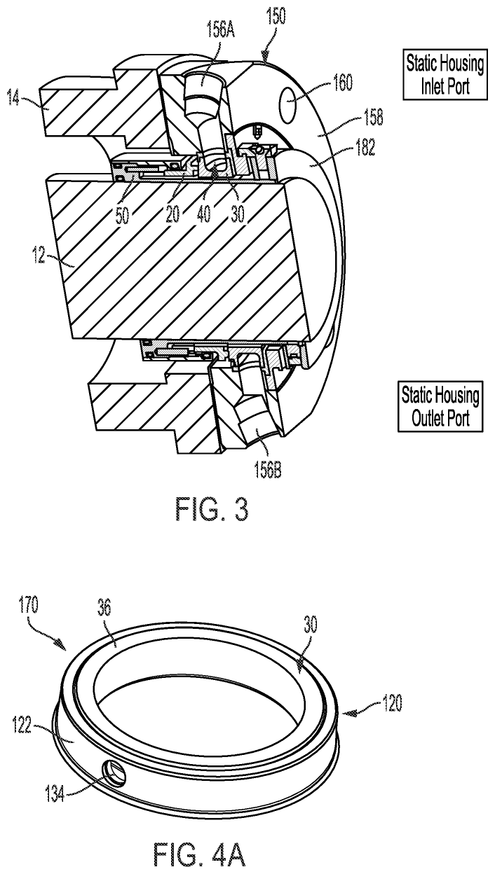

As shown in FIGS. 1 and 3, the illustrated mechanical seal assembly 10 can include a positioning and retention element 140 for seating at an axially outboard end of the seal assembly for positioning and retaining the seal rings 20, 30 therein. The positioning and retention element 140 can have a main body having a top surface 142A and an opposed bottom surface 142B. the bottom surface 142B has a radially extending channel 144 formed therein for seating a portion of the cover element 120. Specifically, the channel 144 is sized and configured to seat the font extension portion 130 and the side portion 128 of the cover element 120.

The mechanical seal assembly 10 can also include a securing assembly 180 for securing the sleeve element 50 to the shaft 12 and for securing in place the positioning and retention element 140, and hence the seal rings 20, 30. The securing assembly 180 can include an annular ring 182 that has a plurality of openings 184 formed therein for seating a fastener element 186, such as a screw. The securing assembly 180 can also include a retention element 190 that is coupled to the annular ring 182 and to the positioning and retention element 140 for securing the positioning and retention element 140 and the annular ring to the mechanical seal assembly 10.

The mechanical seal assembly 10 of the present invention provides a seal between the rotating shaft 12 and a static surface of the stationary equipment 14 for use with variable process fluid temperature requirements or for use in the absence of process liquids, such as in dry running conditions. The mechanical seal assembly 10 includes rotary and stationary axially adjacent annular seal rings 20, 30, respectively. The rotary seal ring 20 is coupled to and rotates with the shaft 12 via the sleeve element 50 and forms a seal with the adjacent stationary seal ring. The sealing surfaces 26, 36 of the seal rings contact each other to form a fluid seal. The securing assembly 180 secures the sleeve element to the shaft 12 and the positioning and retention element 140, also secured to the mechanical seal assembly 10 by the securing assembly 180, positions and retains the seal rings 20, 30 within the seal assembly 10. The biasing assembly 80, which includes the support element 82 and the biasing element 84, positions and biases the sealing surfaces 26, 36 into sealing contact with each other.

The gland element 150 can have one or more fluid ports 156 formed therein for introducing and extracting a heat transfer fluid from the mechanical seal assembly 10. According to one embodiment, the gland element 150 includes at least one fluid inlet port 156A for introducing the heat transfer fluid to the mechanical seal assembly 10 and at least one fluid outlet port 156B for removing the heat transfer fluid from the mechanical seal assembly 10. The number of fluid inlet ports need not match the number of fluid outlet ports. More specifically, the cover element 120 can be seated and mounted over the stationary seal ring 30 and serves to cover and seal the heat transfer channel 40 formed in the outer surface 32A of the seal ring 30. The cover element 120 is adapted and configured to mechanically connect with, via a frictional fit, the stationary seal ring 30 and to overly and seal the channel 40 to form a heat transfer fluid chamber. The fluid openings 134 formed in the cover element 120 are aligned with the fluid ports 156 formed in the gland element 150. The heat transfer fluid introduced into the fluid inlet port 156A passes through the gland element 150 and through the fluid opening 134 of the cover element. The heat transfer fluid is then introduced into the heat transfer channel 40 formed in the outer surface 32A of the stationary seal ring 30. The heat transfer channel 40 and the cover element 120 form the heat transfer fluid chamber. The heat transfer fluid channel 40 is sized and configured to form a low pressure heat transfer channel. The heat transfer fluid as it passes through the low pressure heat transfer channel 40 cools the stationary seal ring 30 during operation by removing heat therefrom. The heat transfer fluid in the channel 40 is then removed from the channel by passing through a fluid opening 134 in the cover element 120 and into the fluid outlet port 156B formed in the gland element 150. The heat transfer fluid can then be removed from the gland element 150. The removed heat transfer fluid can have heat removed therefrom and can be optionally reintroduced into the gland element 150 through the fluid inlet port 156A. The heat transfer channel 40 is sealed against the interior chamber of the gland element 150 by the cover element 120 that is configured to form a housing that completes the channel enclosure and forms a radially sealed fluid chamber. The cover element 120 can be formed from any suitable material, such as from an elastomer material, silicon, silicon carbide, polyurethane, and the like.

The fluid ports 156 formed in the gland element 150 can be axially, radially, and/or circumferentially spaced apart from each other and are preferably aligned with the fluid openings 134 formed in the cover element 120. The heat transfer fluid entering the channel 40 through the fluid inlet port 156A and exiting through the fluid outlet port 156B through the heat transfer channel 40 heats or cools the stationary seal ring 30. In dry running conditions, the mating sealing surfaces of the seal rings generate localized heat due to a lack of lubrication therebetween. A cooled heat transfer fluid can be introduced into the channel 40 to cool the stationary seal ring, and hence both mating surfaces, for extended seal performance. The heat transfer fluid also serves to cool the stationary seal ring 30 independently of the process fluid and associated pressure. Further, the cover element 120 can be sized and configured to provide a maximum contact force exerted by the process fluid pressure against the axial surface of the stationary seal ring 30. The undercut side portion 126 allows for the nesting and unitizing with the stationary seal ring 30. The mechanical seal assembly 10 of the present invention employs an integrated low pressure heat transfer channel 40 formed directly into an outer surface 32A of the stationary seal ring 30, thus eliminating the need to provide and employ an external heat conditioning unit.

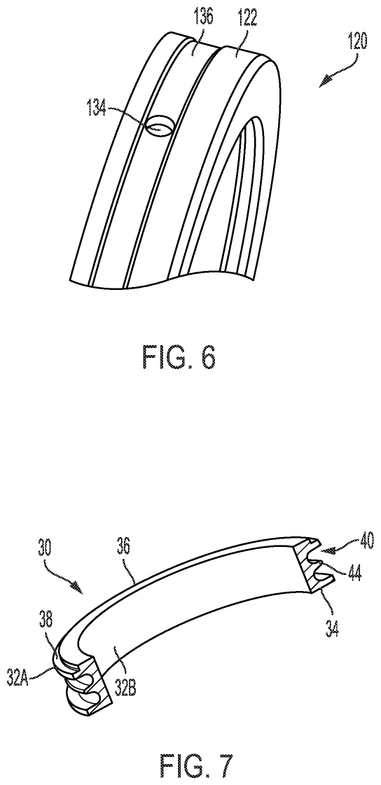

According to an alternate embodiment, as shown in FIG. 6, the cover element 120 can have an outer surface 122 that has a channel 136 formed therein. The channel 136 can have the fluid openings 134 formed therein.

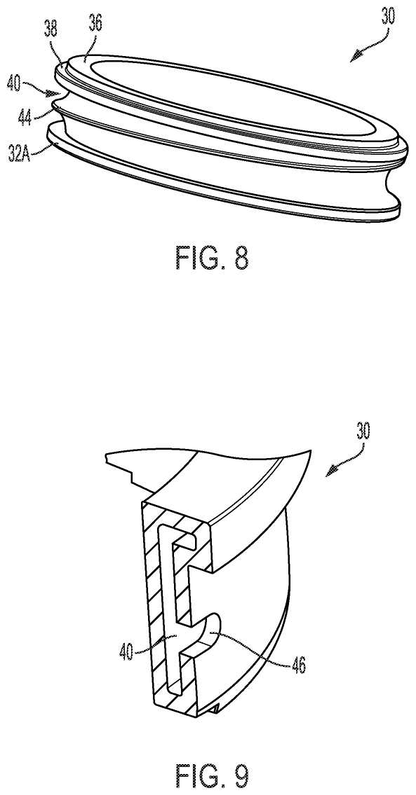

According to still another embodiment, as shown in FIG. 7, the channel 40 formed in the stationary seal ring 30 can employ a surface feature that serves to increase the heat transfer area of the overall channel. According to one embodiment, the illustrated channel 40 can employ a protrusion 44 that extends outwardly from a floor of the channel 40 to form an extended heat transfer element, surface, fin, or wall that serves to increase the size of the overall heat transfer surface of the channel 40. The protrusion 44 can thus form in essence multiple heat transfer channels. The protrusion 44 can have a height that is less than the height of the radially extending wall of the channel 40 to form a recessed radial structure (e.g., fin) to allow for added circulation efficiency of the heat transfer fluid. The protrusion 44 can have any selected size, shape, or configuration. For example, the protrusion 44 can have a spiral or helical shape, as shown for example in FIG. 8. In a spiral configuration, the stationary protrusion 44 of the stationary seal ring 30 can generate a turbulent flow within the channel 40 by disrupting the fluid path formed therein. The turbulent flow of the heat transfer fluid increases the heat transfer efficiency of the channel 40. In a helical configuration, the helical protrusion 44 can allow for enhanced heat transfer fluid circulation within the channel 40.

According to another embodiment, an additive manufacturing technique can be employed to produce or manufacture a stationary seal ring having an integral heat transfer channel 40 that has any selected shape or configuration. For example, the channel 40 can be formed to have four sides with an internal baffle, and an optional additional radial ports, to direct the flow in the channel in specific directions. The additive manufacturing (AM) technique is a manufacturing process that builds an object or structure layer by layer from digital three-dimensional (3D) models. This is in contrast to traditional subtractive manufacturing techniques, where material is removed from a solid workpiece to create the final product. Additive manufacturing techniques enable the creation of complex and intricate geometries that may be challenging or impossible to produce using traditional substrative manufacturing methods.

FIG. 9 illustrates an example of a stationary seal ring 30 having an integrated heat transfer channel 40 having a complex design. The heat transfer channel 40 can have one or more integrated fluid ports 46. The channel 40 has a four-sided configuration that increases the heat transfer efficiency of the channel. In the illustrated embodiment, the cover element need not be employed, and hence supplemental sealing elements can be employed to form a heat transfer pathway between the fluid ports of the gland element 150 and the stationary seal ring 30.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

We claim:

1. A mechanical seal assembly, comprising
a gland element configured to mount to stationary equipment,
a rotary seal ring for coupling to and rotating with a shaft,
a stationary seal ring configured to remain stationary relative to the shaft, wherein the stationary seal ring has a main body having an outer surface having a heat transfer channel formed therein that is sized and configured for circulating a heat transfer fluid, and
a holder element for coupling the rotary seal ring to the shaft and for rotating with the shaft.

2. The mechanical seal assembly of claim 1, further comprising a cover element disposed between the gland element and the stationary seal ring, and wherein the cover element is sized and configured for seating over the heat transfer channel formed in the outer surface of the stationary seal ring.

3. The mechanical seal assembly of claim 2, wherein the cover element has a main body having a plurality of fluid openings formed therein for allowing passage of the heat transfer fluid into the heat transfer channel.

4. The mechanical seal assembly of claim 3, wherein the main body of the cover element includes:
an outer surface and an opposed inner surface,
a first radially inwardly extending side portion formed at one end of the main body, and
a second radially inwardly extending portion formed at an opposed end of the main body.

5. The mechanical seal assembly of claim 4, wherein the outer surface of the stationary seal ring has a stepped surface coupled to the outer surface by a wall surface, wherein the first radially inwardly extending side portion is sized and configured to contact the wall surface of the stationary seal ring and the second radially inwardly extending side portion contacts a top surface of the stationary seal ring to form a fluid tight seal.

6. The mechanical seal assembly of claim 5, wherein the heat transfer channel is a low pressure heat transfer channel.

7. The mechanical seal assembly of claim 6, wherein the first radially inwardly extending side portion is sized and configured to extend partly along the wall surface and is spaced from the stepped surface of the stationary seal ring to form a gap.

8. The mechanical seal assembly of claim 6, wherein the gland element has an inner surface and an opposed outer surface, and a top surface, wherein the top surface has a gland channel formed along an inner radial portion thereof.

9. The mechanical seal assembly of claim 8, wherein the cover element further comprises a radially outwardly extending front extension portion configured for contacting and seating within the gland channel to form a seal against the gland element.

10. The mechanical seal assembly of claim 9, wherein front extension portion forms an anti-rotation mechanism to prevent rotation of the cover element relative to the stationary seal ring.

11. The mechanical seal assembly of claim 6, wherein the gland element has a main body having an inner surface and an opposed outer surface, and has at least one fluid inlet port formed in the main body and at least fluid outlet port formed in the main, wherein each of the fluid inlet port and the fluid outlet port are circumferentially spaced apart from each other and extend completely between the outer surface and the inner surface of the gland element.

12. The mechanical seal assembly of claim 11, wherein the cover element is positioned between the inner surface of the gland element and the outer surface of the stationary seal ring such that the fluid inlet port is aligned with at least one of the plurality of fluid openings and the fluid outlet port is aligned with another one of the plurality of fluid openings.

13. The mechanical seal assembly of claim 12, wherein the holder element comprises a sleeve element having
an axially extending inner surface that is disposed adjacent to an outer surface of the shaft when mounted thereabout and an opposed outer surface, and
a flange end formed at one end for coupling to the rotary seal ring.

14. The mechanical seal assembly of claim 13, further comprising
a connecting pin for coupling to the flange end of the sleeve element for coupling the rotary seal ring to the flange end, and
a biasing assembly disposed within the flange end of the sleeve element for contacting the rotary seal ring and for biasing together a sealing surface of the rotary seal ring and a sealing surface of the stationary seal ring.

15. The mechanical seal assembly of claim 14, wherein the biasing assembly comprises
a support element for contacting an end region of the rotary seal ring opposite the sealing surface, and
a biasing element for contacting the support element for applying an axial biasing force thereto.

16. The mechanical seal assembly of claim 10, further comprising a positioning and retention element disposed so as to contact the front extension portion and the gland element for positioning and retaining the stationary seal ring within the gland element.

17. The mechanical seal assembly of claim 16, further comprising a securing assembly for securing the sleeve element to the shaft and for securing in place the positioning and retention element.

18. The mechanical seal assembly of claim 3, wherein the heat transfer channel of the stationary seal ring has a floor portion having one or more protrusions radially outwardly extending therefrom to form an extended heat transfer element that increases the size of the heat transfer surface of the heat transfer channel.

19. The mechanical seal assembly of claim 18, wherein the protrusion has a height that is less than a height of a radially extending wall element of the channel to promote circulation of the heat transfer fluid within the channel.

20. The mechanical seal assembly of claim 19, wherein the protrusion has a spiral or helical shape to generate a turbulent flow of the heat transfer fluid within the heat transfer channel.
